(19) United States
(12) Patent Application Publication
(10) Pub. No.: US 2014/0379634 A1
(43) Pub. Date: Dec. 25, 2014

(54) APPLICATION-TO-REPOSITORY DATA MAPPING IN DATA REPOSITORIES, AND RELATED METHODS, SYSTEMS, AND COMPUTER-READABLE MEDIA

(71) Applicant: Avaya Inc., Basking Ridge, NJ (US)

(72) Inventors: John H. Yoakum, Cary, NC (US); Kundan Singh, San Francisco, CA (US)

(21) Appl. No.: 13/923,748

(22) Filed: Jun. 21, 2013

(51) Int. Cl. G06F 17/30

(52) U.S. Cl. CPC G06F 17/3056
USPC 707/609; 707/756

(57) ABSTRACT

Application-to-repository data mapping in data repositories is disclosed herein. Related methods, systems, and computer-readable media are also disclosed. In this regard, in one embodiment, a method for providing application-to-repository data mapping in a data repository is provided. The method comprises receiving, by a data repository, a definition of a named data object from an application. The method further includes generating a mapping of the named data object to a data element stored in the data repository. The method also comprises storing the mapping as application metadata in a predefined data structure in the data repository. The method additionally comprises providing, to the application, access to the data element based on the mapping of the named data object to the data element. The data repository thus provides a metadata architecture minimizing the impact of changes to the data repository, while also simplifying sharing of data among applications.

### BACKGROUND

1. Field of the Disclosure

The technology of the disclosure relates generally to repositories for storing shared application data.

2. Technical Background

Distributed applications are software systems composed of application components that are located on networked computers, and that communicate via one or more public and/or private networks to coordinate operations. A distributed application is typically structured according to a multi-tiered architecture, in which presentation, application processing, and data management of the distributed application are logically separated into tiers. The use of a multi-tiered architecture may permit components and data of the distributed application to be more efficiently developed, maintained, and reused. In particular, segregating data of the distributed application from its functional elements may permit the data to be reused and shared among multiple distributed applications.

One approach to segregating data from application functionality involves storing data in a data repository that may be accessed by numerous distributed applications. By providing access to shared data, the data repository enables the development of “mashups,” which are applications that combine or aggregate data from two or more sources to provide new services beyond the original purpose of the source data. In this manner, mashups may provide enriched services that may not have been anticipated or intended by the creators of the source data.

As new distributed applications make new shared data available in the data repository, the data repository may need to modify or reorganize data elements stored therein. For example, modifications may be required to provide storage for new data, and/or to make the new data discoverable and accessible by applications. However, the dynamic nature of a data repository may pose challenges to the development and maintenance of the distributed applications. Modifications to the data elements may require that each distributed application that interacts with the data repository be individually updated to maintain data accessibility for the distributed application. This may be problematic in circumstances in which an owner of the data repository does not have visibility to all of the distributed applications that may be using the data repository. These issues may be mitigated by including an intermediate mapping layer between a distributed application and the data repository, but at a cost of increased complexity of the distributed application.

### SUMMARY OF THE DETAILED DESCRIPTION

Embodiments disclosed in the detailed description provide application-to-repository data mapping in data repositories. Related methods, systems, and computer-readable media are also disclosed. In some embodiments, a named data object defined by an application is mapped to a corresponding data element in a data repository. The mapping for the named data object is stored as application metadata corresponding to the application within the data repository. The application can then access data by invoking the named data object in the data repository. In this manner, a metadata architecture within the data repository is provided that minimizes the impact of changes to the data repository, while also simplifying sharing of data among multiple applications.

In this regard, in one embodiment, a method for providing application-to-repository data mapping in a data repository is provided. The method comprises receiving, by a data repository executing on a computing device, a definition of a named data object from an application. The method further comprises generating a mapping of the named data object to a data element stored in the data repository. The method also comprises storing the mapping as application metadata in a predefined data structure in the data repository. The method additionally comprises providing, to the application, access to the data element based on the mapping of the named data object to the data element.

In another embodiment, a system for providing application-to-repository data mapping in a data repository is provided. The system comprises at least one communications interface, and a data repository associated with the at least one communications interface. The data repository comprises a data mapping provider that is configured to receive a definition of a named data object from an application. The data mapping provider is further configured to generate a mapping of the named data object to a data element stored in the data repository. The data mapping provider is also configured to store the mapping as application metadata in a predefined data structure in the data repository. The data mapping provider is additionally configured to provide, to the application, access to the data element based on the mapping of the named data object to the data element.

In another embodiment, a non-transitory computer-readable medium is provided. The non-transitory computer-readable medium has stored thereon computer-executable instructions to cause a processor to implement a method comprising receiving a definition of a named data object from an application. The method implemented by the computer-executable instructions further comprises generating a mapping of the named data object to a data element stored in the data repository. The method implemented by the computer-executable instructions also comprises storing the mapping as application metadata in a predefined data structure in the data repository. The method implemented by the computer-executable instructions further comprises providing, to the application, access to the data element based on the mapping of the named data object to the data element.

### BRIEF DESCRIPTION OF THE FIGURES

The accompanying drawing figures incorporated in and forming a part of this specification illustrate several aspects of the disclosure, and together with the description serve to explain the principles of the disclosure.

FIG. 1 is a schematic diagram illustrating a data repository, including a data mapping provider for enabling application-to-repository data mapping within the data repository;

FIG. 2 is a flowchart illustrating exemplary operations of the data mapping provider of FIG. 1 for providing application-to-repository data mapping;

FIG. 3 is a schematic diagram illustrating an exemplary application-to-repository data mapping resulting from a modification of a data element in the data repository of FIG. 1;

FIG. 4 is a schematic diagram illustrating an exemplary application-to-repository data mapping resulting from a change to an application-defined named data object;

FIGS. 5A and 5B are flowcharts illustrating more detailed exemplary operations for application-to-repository data mapping, including applying permissions for updating application metadata;

FIG. 6 is a diagram illustrating an exemplary embodiment of an application metadata table; and

FIG. 7 is a block diagram of an exemplary processor-based system that may include the data mapping provider of FIG. 1.

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

Embodiments disclosed in the detailed description provide application-to-repository data mapping in data repositories. Related methods, systems, and computer-readable media are also disclosed. In some embodiments, a named data object defined by an application is mapped to a corresponding data element in a data repository. The mapping for the named data object is stored as application metadata corresponding to the application within the data repository. The application can then access data by invoking the named data object in the data repository. In this manner, a metadata architecture within the data repository is provided that minimizes the impact of changes to the data repository, while also simplifying sharing of data among multiple applications.

In this regard, in one embodiment, a method for providing application-to-repository data mapping in a data repository is provided. The method comprises receiving, by a data repository executing on a computing device, a definition of a named data object from an application. The method further comprises generating a mapping of the named data object to a data element stored in the data repository. The method also comprises storing the mapping as application metadata in a predefined data structure in the data repository. The method additionally comprises providing, to the application, access to the data element based on the mapping of the named data object to the data element. In some embodiments, providing access to the data element includes providing the mapping to the application, after which the application may access the data element directly. Some embodiments may provide that providing access to the data element includes accessing the data element on behalf of the application, and returning requested data to the application.

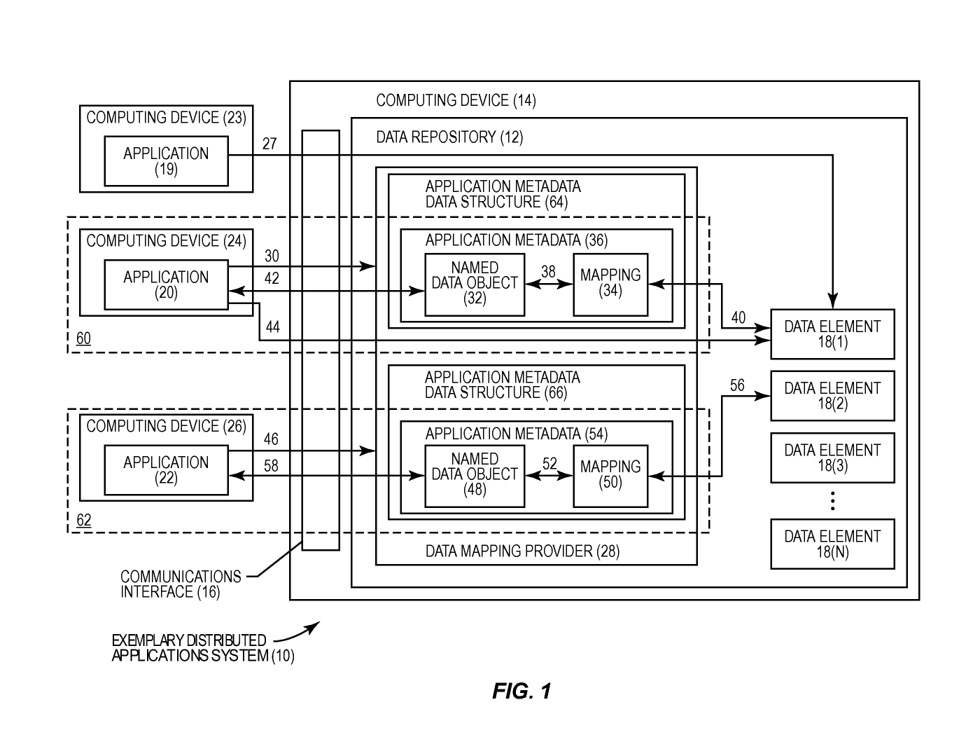

FIG. 1 shows an exemplary distributed applications system 10 providing application-to-repository data mapping as disclosed herein. The distributed applications system 10 includes a data repository 12 executing on a computing device 14. In some embodiments, the computing device 14 may be any computing device having network communications capabilities, such as a smartphone, a tablet computer, a dedicated web appliance, a media server, or a desktop or server computer, as non-limiting examples. The computing device 14 includes a communications interface 16 (such as, e.g., one or more network interface devices) for connecting the computing device 14 to one or more public and/or private networks. The data repository 12 provides storage for and access to data elements 18(1)-18(N). In some embodiments, the data elements 18(1)-18(N) may be elements of a file system, a relational database, an object-oriented database, a distributed data store, or a directory service, or combinations thereof.

The distributed applications system 10 of FIG. 1 further includes applications 19, 20, and 22, executing on computing devices 23, 24, and 26, respectively. Some embodiments of the distributed applications system 10 of FIG. 1 may provide that each of the computing devices 23, 24, and 26 may be any computing device having network communications capabilities, such as a smartphone, a tablet computer, a dedicated web appliance, a media server, or a desktop or server computer, as non-limiting examples. The applications 19, 20, and 22 represent distributed applications that are configured to utilize data housed in the data repository 12. It is to be understood that the applications 19, 20, and 22 may each comprise more elements than are illustrated in FIG. 1, may each be distributed across more than one computing device 23, 24, 26, and/or may utilize more than one data repository 12. It is to be further understood that the computing devices 14, 23, 24, and 26 may be located within the same public or private network, or may be located within separate, communicatively coupled public and/or private networks.

In the example of FIG. 1, the application 19 requires access to data that is stored in the data repository 12 as the data element 18(1) Likewise, the application 20 requires access to data that is stored in the data repository 12 as the data element 18(1), and the application 22 requires access to data stored in the data repository 12 as the data element 18(2). As seen in FIG. 1, the application 19 accesses the data element 18(1) by hard-coding or otherwise expressly identifying the data element 18(1) within the application 19, as indicated by arrow 27. The application 19 is thus “tightly coupled” to the data element 18(1). In other words, a modification to the data element 18(1) within the data repository 12 (e.g., to provide storage for new data and/or to make data discoverable and accessible by other applications) would require that the application 19 be updated as well. Otherwise, the application 19 may lose access to required data, and consequently may suffer a loss of some or all functionality.

Accordingly, in this regard, the data repository 12 includes a data mapping provider 28 for providing application-to-repository data mapping within the data repository 12 to effectively “decouple” (i.e., avoid direct dependencies between) each of the applications 20 and 22 and the data elements 18. In this example, the data mapping provider 28 receives a definition (represented by arrow 30) of a named data object 32 from the application 20. In some embodiments, the definition 30 is provided to the data mapping provider 28 at an application design time by a designer or developer of the application 20. The named data object 32 may represent an application-specific alias or handle for a corresponding data element, such as the data element 18(1). The named data object 32 may be a new data object to be created in the data mapping provider 28, or may be an existing data object in the data mapping provider 28. Accordingly, the definition 30 may include a name or handle for a new named data object 32 to be created in the data mapping provider 28, and/or a selection of an existing named data object 32 in the data mapping provider 28. The definition 30 also includes an indication of the corresponding data element, such as the data element 18(1), and may include other application-specific attributes of the named data object 32.

Based on the definition 30, the data mapping provider 28 in this example generates a mapping 34 of the named data object 32 to the data element 18(1), and stores a reference to the named data object 32 and the mapping 34 as application metadata 36. As used herein, “application metadata” refers to stored data referencing and/or describing attributes of the named data object 32 and the mapping 34 to the corresponding data element 18(1). In some embodiments, the application metadata 36 may include application-specific attributes of the named data object 32, such as an associated data type, a namespace, and/or a read-only flag, as non-limiting examples. As indicated by bidirectional arrows 38 and 40, the mapping 34 serves as a link between the named data object 32 and the data element 18(1). The application 20 may access data at the data element 18(1) by invoking the named data object 32 and using it for data access, as indicated by bidirectional arrow 42. The data mapping provider 28 then provides the application 20 with access to the data element 18(1) based on the mapping 34 of the named data object 32 to the data element 18(1). In this example, the data mapping provider 28 provides the application 20 with the mapping 34, which the application 20 may then utilize to directly access the data element 18(1), as indicated by arrow 44.

As seen in FIG. 1, the data mapping provider 28 also receives from the application 22 a definition (represented by the arrow 46) of a named data object 48. The data mapping provider 28 then generates a mapping 50 of the named data object 48 to the data element 18(2) as indicated by arrow 52, and stores a reference to the named data object 48 and the mapping 50 as application metadata 54. As indicated by arrows 52 and 56, the mapping 50 serves to link the named data object 48 with the data element 18(2). The application 22 may access data at the data element 18(2) by invoking the named data object 48 and using it for data accesses, as indicated by bidirectional arrow 58. The data mapping provider 28 then provides the application 22 with access to the data element 18(2) based on the mapping 50 of the named data object 48 to the data element 18(2). In this embodiment, the data mapping provider 28 may receive a data request for the named data object 48 from the application 22. The data mapping provider 28 may then access the data element 18(2) based on the mapping 50, and return requested data to the application 22.

In some embodiments, one or more of the data elements 18 may be accessed and/or updated by more than one of the applications 20 and 22. Such data elements 18 may be considered “shared data.” In cases of concurrent access to shared data, the data repository 12 handles issues related to atomicity, consistency, isolation, and durability of the shared data according to techniques known in the art.

In some embodiments, permissions to modify a mapping, such as the mappings 34 or 50, may be limited once the mapping is generated by the data mapping provider 28. For instance, the data mapping provider 28 may limit permissions for updating a mapping of a named data object to an owner of an application corresponding to the named data object and an owner of the data repository 12. Similarly, some embodiments may limit permissions for updating a named data object to an owner of an application corresponding to the named data object. In this manner, for example, an application owner may modify a name of an existing named data object without impacting either data stored within the data repository 12 or application metadata, such as application metadata 36 and 54, for other applications. In FIG. 1, dotted box 60 indicates that the named data object 32 and the mapping 34 “belong” to the application 20 (i.e., the owner of the application 20 has permissions to update the named data object 32 and the mapping 34) Likewise, dotted box 62 indicates that the named data object 48 and the mapping 50 belong to the application 22.

According to some embodiments described herein, the data mapping provider 28 may store the application metadata 36 in an application metadata data structure 64 corresponding to the application 20, and may further store the application metadata 54 in an application metadata data structure 66 corresponding to the application 22. In some embodiments, the application metadata data structures 64 and 66 conform to a predefined structure. Some embodiments may provide that the application metadata data structures 64 and 66 comprise relational database tables, object-oriented database entities, and/or other data structures, as non-limiting examples. By storing application metadata in an application metadata data structure corresponding to a given application, the application metadata specific to the given application may be isolated from application metadata for other applications. Thus, the potential for negative interactions between applications may be decreased or eliminated.

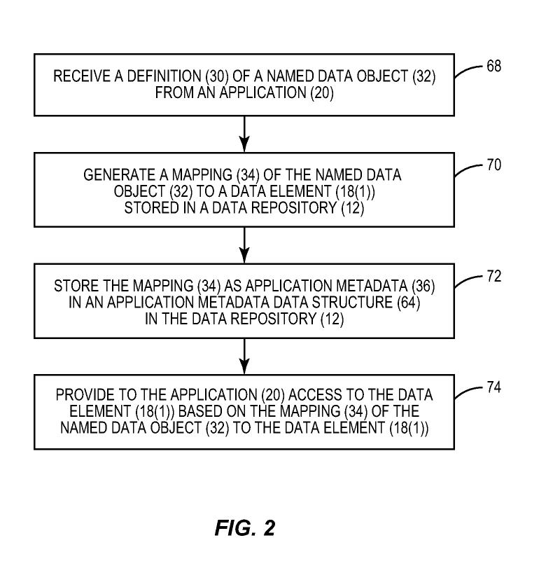

To generally describe exemplary operations of the data mapping provider 28 of FIG. 1 for providing application-to-repository data mapping in the data repository 12, FIG. 2 is provided. For the sake of clarity, elements of FIG. 1 are referenced in describing FIG. 2. In the example of FIG. 2, operations begin with the data mapping provider 28 of the data repository 12 receiving a definition 30 of a named data object 32 from an application 20 (block 68). As discussed above, the application 20 may be a distributed application communicating with the data repository 12 via a public and/or private network. The definition 30 of the named data object 32 may be specified by a designer of the application 20, and may identify a data element, such as the data element 18(1) in the data repository 12. In some embodiments, the named data object 32 serves as an interface by which the application 20 may access data stored at the data element 18(1) within the data repository 12.

With continuing reference to FIG. 2, the data mapping provider 28 next generates a mapping 34 of the named data object 32 to the data element 18(1) stored in the data repository 12 (block 70). The mapping 34 provides a link between the named data object 32 and the data element 18(1) stored in the data repository 12. The data mapping provider 28 then stores the mapping 34 as application metadata 36 in the data repository 12 (block 72). In some embodiments, the application metadata 36 is stored in an predefined data structure that corresponds to the application 20, such as the application metadata data structure 64 of FIG. 1. Thus, metadata for each of a plurality of applications may be separated, preventing any modifications to application metadata for one application from impacting other applications utilizing the data repository 12.

The data mapping provider 28 provides access to the data element 18(1) by the application 20 based on the mapping 34 of the named data object 32 to the data element 18(1) (block 74). In some embodiments, providing access to the data element 18(1) includes the data mapping provider 28 providing the mapping 34 to the application 20, after which the application 20 may access the data element 18(1) directly. Some embodiments may provide that providing access to the data element 18(1) includes the data mapping provider 28 accessing the data element 18(1) on behalf of the application 20, and returning requested data to the application 20. By using the mapping 34 to map the named data object 32 to the data element 18(1), the data mapping provider 28 may provide access to data in the data repository 12 by the application 20, while enabling the data element 18(1) to be modified or reorganized without requiring changes to the application 20.

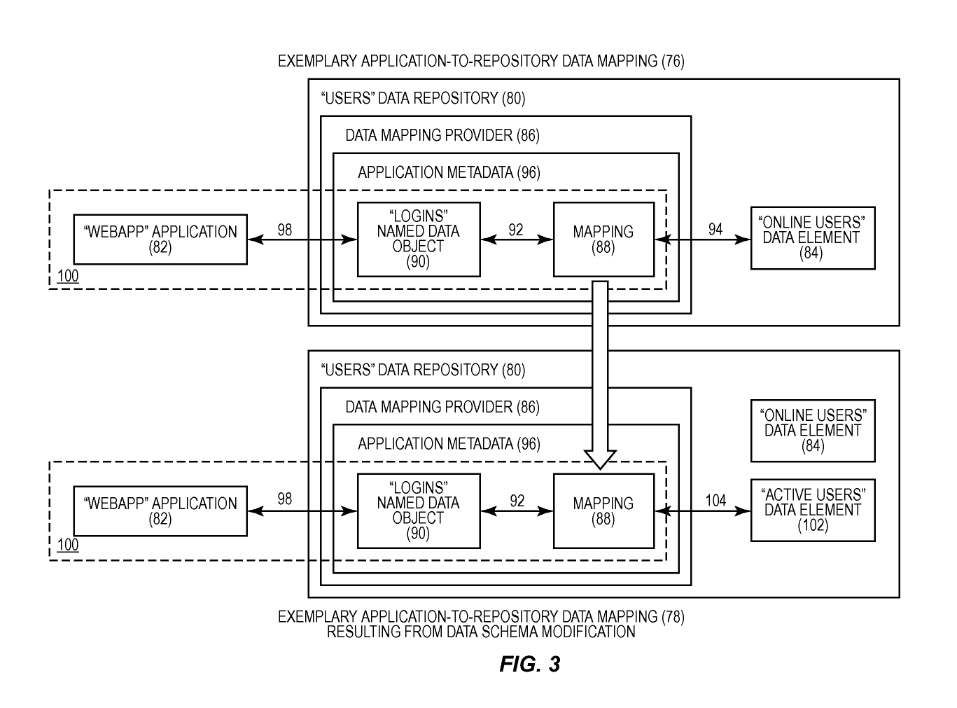

By mapping an application-defined named data object to a data element, the data mapping provider 28 of FIG. 1 may enable changes to be made to the data repository 12 without requiring any modifications to the applications 20 and 22 utilizing the data repository 12. In this regard, FIG. 3 is provided to illustrate a modification to an exemplary application-to-repository data mapping 76 and a resulting exemplary application-to-repository data mapping 78. In the exemplary data mapping 76 of FIG. 3, a “Users” data repository 80 is provided for storage and management of data for a “WebApp” application 82. The “Users” data repository 80 includes an “Online Users” data element 84. The “Users” data repository 80 further provides a data mapping provider 86.

As seen in the exemplary data mapping 76, the data mapping provider 86 has generated a mapping 88 of a “Logins” named data object 90 defined by the “WebApp” application 82 to the “Online Users” data element 84. The mapping 88 thus links the “Logins” named data object 90 to the “Online Users” data element 84, as indicated by arrows 92 and 94. The mapping 88 and the “Logins” named data object 90 are stored in the “Users” data repository 80 as application metadata 96. The “WebApp” application 82 may access data stored at the “Online Users” data element 84 in the “Users” data repository 80 by invoking and accessing the “Logins” named data object 90, as indicated by arrow 98. As indicated by dotted box 100, the “Logins” named data object 90 and the mapping 88 belong to the “WebApp” application 82, in that the owner of the “WebApp” application 82 has update permissions for the “Logins” named data object 90 and the mapping 88.

With continuing reference to FIG. 3, the exemplary application-to-repository data mapping 78 illustrates how the data mapping provider 86 handles a modification of the “Users” data repository 80 affecting the “Online Users” data element 84 to which the “Logins” named data object 90 is mapped. In this example, data represented by the “Online Users” data element 84 has been relocated to an “Active Users” data element 102, and the “Users” data repository 80 has been updated accordingly. To preserve the ability of the “WebApp” application 82 to access data using the “Logins” named data object 90, the data mapping provider 96 updates the mapping 88 to map the “Logins” named data object 90 to the “Active Users” data element 102, as indicated by arrows 92 and 104. Consequently, no modifications are necessary to the “Logins” named data object 90 or to the “WebApp” application 82 as a result of the modification to the “Users” data repository 80. As noted above with respect to FIG. 1, some embodiments may provide that the data mapping provider 86 may limit permissions to modify the mapping 88 to an owner of the “WebApp” application 82 and an owner of the “Users” data repository 80.

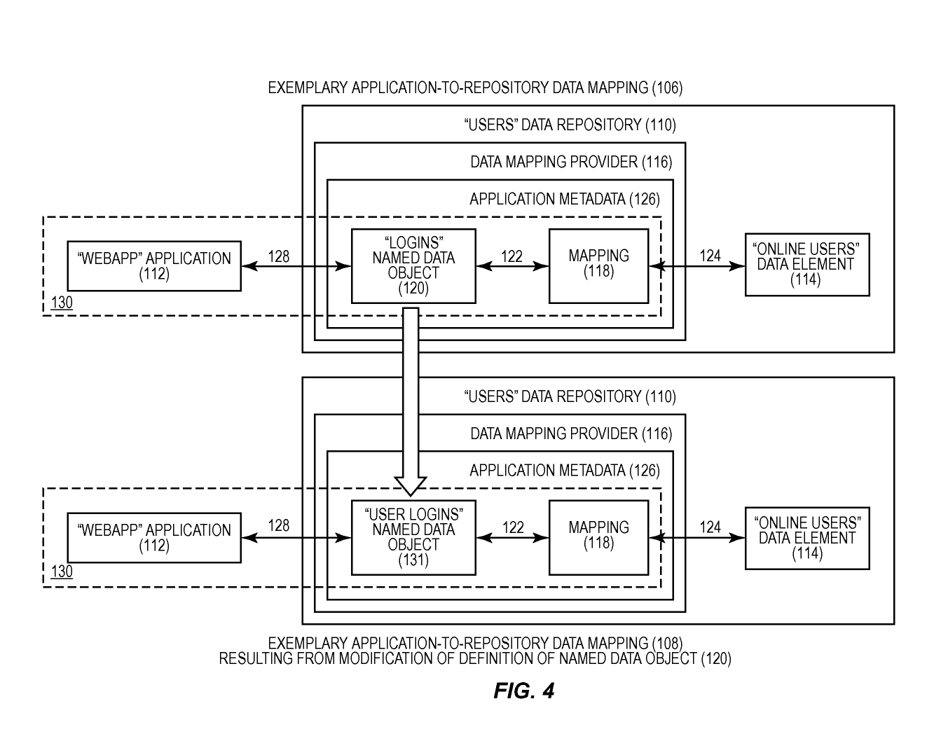

The data mapping provider 28 of FIG. 1 may also enable changes to be made to a definition of a named data object without requiring any modifications to a data element stored in the data repository 12. Accordingly, FIG. 4 illustrates a modification to a named data object in an exemplary application-to-repository data mapping 106 and a resulting exemplary application-to-repository data mapping 108. As in FIG. 3, FIG. 4 shows a “Users” data repository 110 provided for storage and management of data for a “WebApp” application 112. The “Users” data repository 110 includes an “Online Users” data element 114. The “Users” data repository 110 further provides a data mapping provider 116, which has generated a mapping 118 of a “Logins” named data object 120 defined by the “WebApp” application 112 to the “Online Users” data element 114. The mapping 118 thus links the “Logins” named data object 120 to the “Online Users” data element 114, as indicated by arrows 122 and 124. The mapping 118 and the “Logins” named data object 120 are stored in the “Users” data repository 110 as application metadata 126. The “WebApp” application 112 may access data stored at the “Online Users” data element 114 in the “Users” data repository 110 by invoking and accessing the “Logins” named data object 120, as indicated by arrow 128. As indicated by dotted box 130, the “Logins” named data object 120 and the mapping 118 belong to the “WebApp” application 112 (i.e., an owner of the “WebApp” application 112 has update permissions for the “Logins” named data object 120 and the mapping 118).

The exemplary application-to-repository data mapping 108 illustrates how the data mapping provider 116 of FIG. 4 handles a modification of a definition of the “Logins” named data object 120. In this example, the “WebApp” application 112 has redefined the “Logins” named data object 120 by renaming it to a “User Logins” named data object 131. Because the data mapping provider 116 separates the original “Logins” named data object 120 and the mapping 118 from the “Online Users” data element 114, no modifications to the “Online Users” data element 114 are required as a result of the modification of the “Logins” named data object 120 into the “User Logins” named data object 131. As noted above with respect to FIG. 1, some embodiments may provide that the data mapping provider 116 may limit permissions to modify the “Logins” named data object 120 to an owner of the “WebApp” application 112.

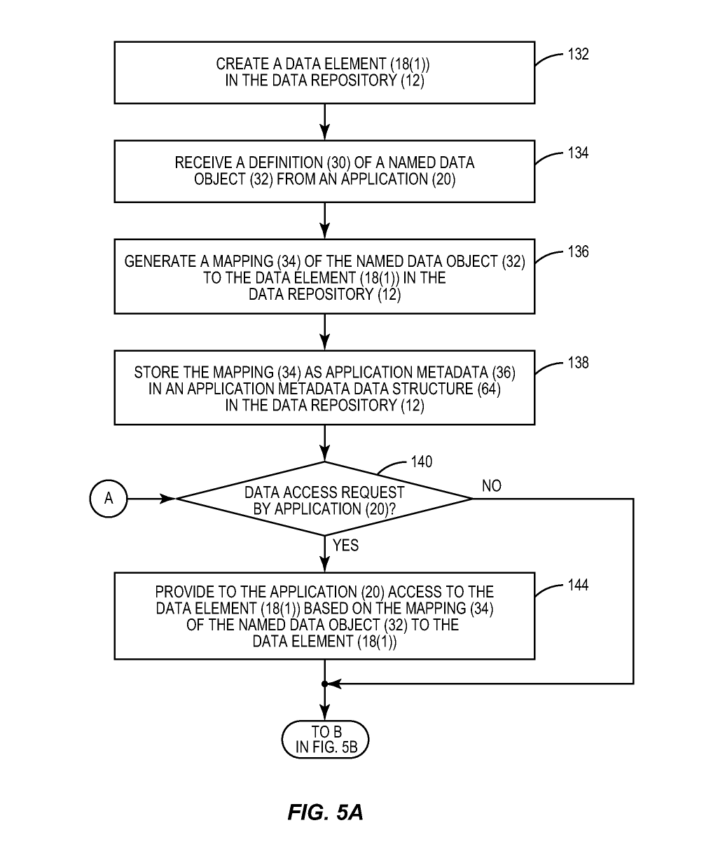

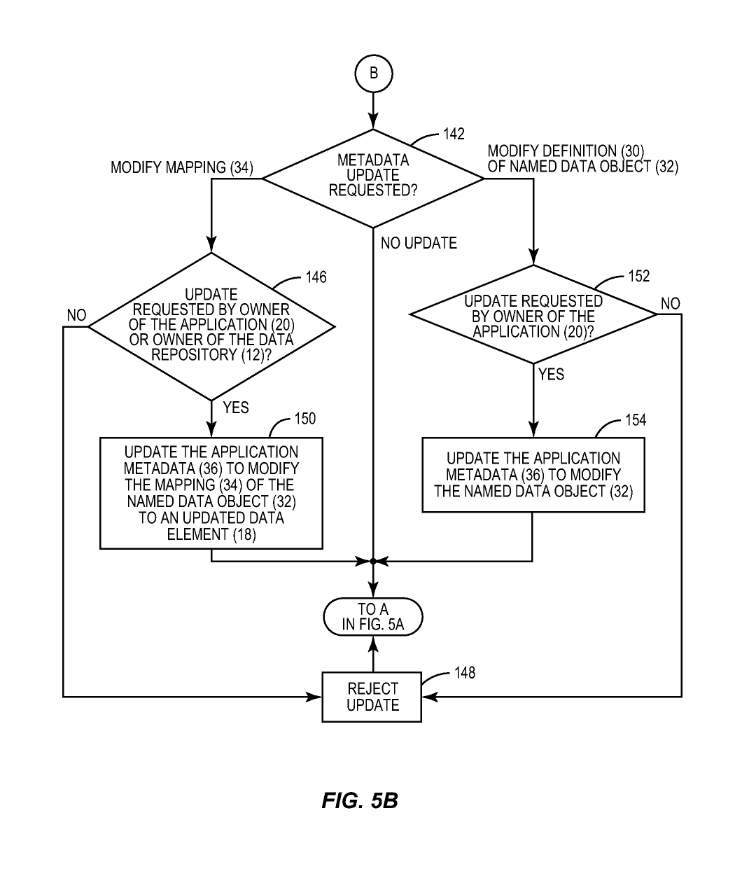

FIGS. 5A and 5B are provided to illustrate in greater detail an exemplary generalized process for the data mapping provider 28 of FIG. 1 to provide application-to-repository data mapping in the data repository 12. For illustrative purposes, FIGS. 5A and 5B refer to elements of the distributed applications system 10 and the data mapping provider 28 of FIG. 1. FIG. 5A details operations for generating the mapping 34 of the named data object 32 to the data element 18(1), and providing data access to the application 20 based on the mapping 34. FIG. 5B shows operations for updating the application metadata 36 based on permissions limiting access to the mapping 34 and the named data object 32.

In FIG. 5A, processing begins with the data mapping provider 28 creating a data element, such as the data element 18(1), in the data repository 12 (block 132). The data mapping provider 28 next receives a definition 30 of a named data object 32 from an application 20 (block 134). The data mapping provider 28 then generates a mapping 34 of the named data object 32 to the data element 18(1) in the data repository 12 (block 136). The data mapping provider 28 then stores the mapping 34 as application metadata 36 in an application metadata structure 64 in the data repository 12 (block 138).

The data mapping provider 28 next determines whether a data access request to the named data object 32 has been received from the application 20 (block 140). If not, processing proceeds to block 142 of FIG. 5B. If the data mapping provider 28 determines at decision block 140 that a data access request has been received, the data mapping provider 28 provides access to the data element 18(1) by the application 20 based on the mapping 34 of the named data object 32 to the data element 18(1) (block 144). In some embodiments, providing access to the data element 18(1) includes the data mapping provider 28 providing the mapping 34 to the application 20, after which the application 20 may access the data element 18(1) directly. Some embodiments may provide that providing access to the data element 18(1) includes the data mapping provider 28 accessing the data element 18(1) on behalf of the application 20, and returning requested data to the application 20. Processing then resumes at block 142 of FIG. 5B.

Referring now to FIG. 5B, the data mapping provider 28 determines whether a request to update the application metadata 36 has been received (e.g., from an owner of the data repository 12 and/or from an owner of the application 20) (block 142). If not, processing returns to block 140 in FIG. 5A. If a metadata update including a request to modify the mapping 34 of the named data object 32 is received, the data mapping provider 28 examines whether the metadata update was requested by an owner of the application 20 or an owner of the data repository 12 (block 146). In some embodiments, the data mapping provider 28 may limit permissions for updating the mapping 34 of the named data object 32 to the owner of the application 20 or the owner of the data repository 12. Accordingly, if the metadata update was requested by an entity other than the owner of the application 20 or the owner of the data repository 12, the data mapping provider 28 rejects the update (block 148), and processing proceeds to block 140 of FIG. 5A. However, if the metadata update was requested by the owner of the application 20 or the owner of the data repository 12, the data mapping provider 28 updates the application metadata 36 to modify the mapping 34 of the named data object 32 to an updated data element 18 (block 150). Processing then resumes at block 140 of FIG. 5A.

If the data mapping provider 28 determines at decision block 142 of FIG. 5B that a metadata update including a request to modify the named data object 32 is received, the data mapping provider 28 examines whether the metadata update was requested by the owner of the application 20 (block 152). Some embodiments may provide that the data mapping provider 28 may limit permissions for updating the mapping 34 of the named data object 32 to the owner of the application 20. Thus, if the metadata update was requested by an entity other than the owner of the application 20, the data mapping provider 28 rejects the update (block 148), and processing proceeds to block 140 of FIG. 5A. However, if the metadata update was requested by the owner of the application 20, the data mapping provider 28 updates the application metadata 36 to modify the named data object 32 (block 154). In some embodiments, this may include changing a name or a handle by which the named data object 32 is referenced by the application 20. Processing then resumes at block 140 of FIG. 5A.

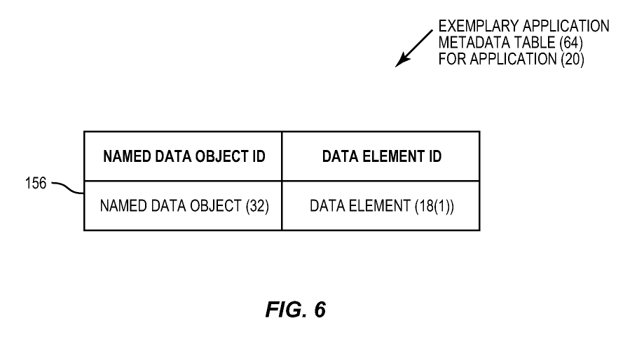

As discussed above, application metadata generated by the data mapping provider 28 of FIG. 1 may be stored in a predefined data structure corresponding to an application, such as the application metadata data structure 64 of FIG. 1. FIG. 6 illustrates an exemplary application metadata data structure 64 according to some embodiments disclosed herein. In FIG. 6, the application metadata data structure 64 comprises a relational database table including a row 156 for storing attributes relating to a named data object 32 for the application 20. The row 156 includes two columns, one for storing an identifier of a named data object and one for an identifier of a data element to which the named data object is mapped. Accordingly, the row 156 in the application metadata data structure 64 stores an identifier for the named data object 32 and an identifier for the data element 18(1) to which the named data object 32 is mapped by the data mapping provider 28. It is to be understood that the application metadata data structure 64 may include additional columns, elements, or objects to store further attributes of a named data object, a data element, and/or a corresponding application or relationship, as necessary. It is to be further understood that the data mapping provider 28 may comprise a plurality of application metadata tables 64 corresponding to a plurality of applications.

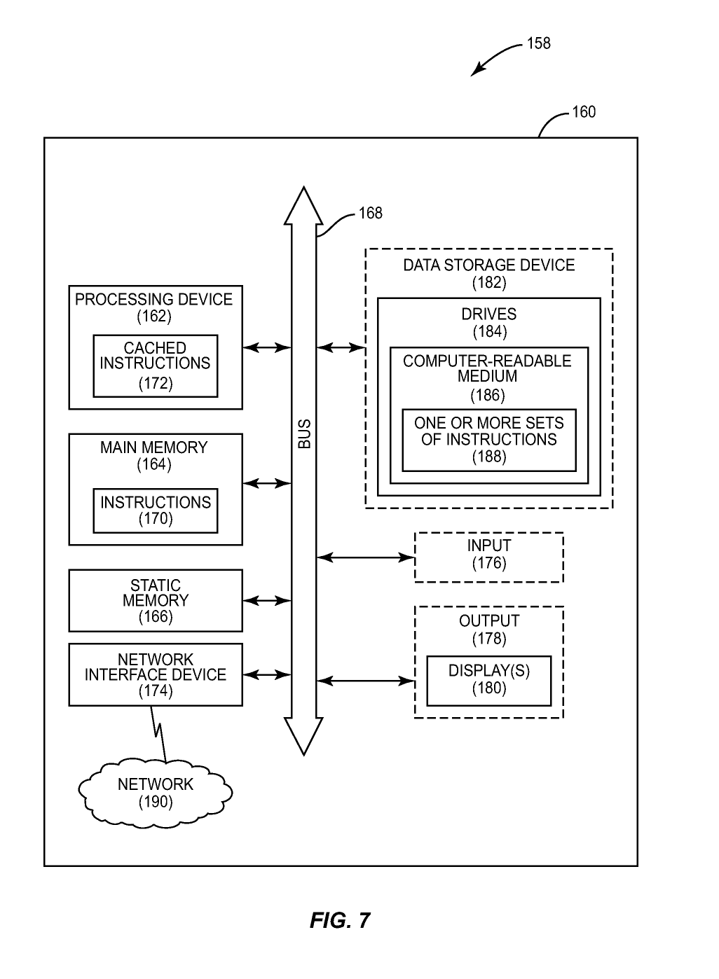

FIG. 7 provides a schematic diagram representation of a processing system 158 in the exemplary form of an exemplary computer system 160 adapted to execute instructions to perform the functions described herein. In some embodiments, the processing system 158 may execute instructions to perform the functions of the data mapping provider 28 of FIG. 1. In this regard, the processing system 158 may comprise the computer system 160, within which a set of instructions for causing the processing system 158 to perform any one or more of the methodologies discussed herein may be executed. The processing system 158 may be connected (as a non-limiting example, networked) to other machines in a local area network (LAN), an intranet, an extranet, or the Internet. The processing system 158 may operate in a client-server network environment, or as a peer machine in a peer-to-peer (or distributed) network environment. While only a single processing system 158 is illustrated, the terms “controller” and “server” shall also be taken to include any collection of machines that individually or jointly execute a set (or multiple sets) of instructions to perform any one or more of the methodologies discussed herein. The processing system 158 may be a server, a personal computer, a desktop computer, a laptop computer, a personal digital assistant (PDA), a computing pad, a mobile device, or any other device and may represent, as non-limiting examples, a server or a user's computer.

The exemplary computer system 160 includes a processing device or processor 162, a main memory 164 (as non-limiting examples, read-only memory (ROM), flash memory, dynamic random access memory (DRAM) such as synchronous DRAM (SDRAM), etc.), and a static memory 166 (as non-limiting examples, flash memory, static random access memory (SRAM), etc.), which may communicate with each other via a bus 168. Alternatively, the processing device 162 may be connected to the main memory 164 and/or the static memory 166 directly or via some other connectivity means.

The processing device 162 represents one or more processing devices, such as a microprocessor, central processing unit (CPU), or the like. More particularly, the processing device 162 may be a complex instruction set computing (CISC) microprocessor, a reduced instruction set computing (RISC) microprocessor, a very long instruction word (VLIW) microprocessor, a processor implementing other instruction sets, or a processor implementing a combination of instruction sets. The processing device 162 is configured to execute processing logic in instructions 170 and/or cached instructions 172 for performing the operations and steps discussed herein.

The computer system 160 may further include a communications interface in the form of a network interface device 174. It also may or may not include an input 176 to receive input and selections to be communicated to the computer system 160 when executing the instructions 170, 172. It also may or may not include an output 178, including but not limited to display(s) 180. The display(s) 180 may be a video display unit (as non-limiting examples, a liquid crystal display (LCD) or a cathode ray tube (CRT)), an alphanumeric input device (as a non-limiting example, a keyboard), a cursor control device (as a non-limiting example, a mouse), and/or a touch screen device (as a non-limiting example, a tablet input device or screen).

The computer system 160 may or may not include a data storage device 182 that includes using drive(s) 184 to store the functions described herein in a computer-readable medium 186, on which is stored one or more sets of instructions 188 (e.g., software) embodying any one or more of the methodologies or functions described herein. The functions can include the methods and/or other functions of the processing system 158, a participant user device, and/or a licensing server, as non-limiting examples. The one or more sets of instructions 188 may also reside, completely or at least partially, within the main memory 164 and/or within the processing device 162 during execution thereof by the computer system 160. The main memory 164 and the processing device 162 also constitute machine-accessible storage media. The instructions 170, 172, and/or 188 may further be transmitted or received over a network 190 via the network interface device 174. The network 190 may be an intra-network or an inter-network.

While the computer-readable medium 186 is shown in an exemplary embodiment to be a single medium, the term “machine-accessible storage medium” should be taken to include a single medium or multiple media (as non-limiting examples, a centralized or distributed database, and/or associated caches and servers) that store the one or more sets of instructions 188. The term “machine-accessible storage medium” shall also be taken to include any medium that is capable of storing, encoding, or carrying a set of instructions 170, 172, and/or 188 for execution by the machine, and that cause the machine to perform any one or more of the methodologies disclosed herein. The term “machine-accessible storage medium” shall accordingly be taken to include, but not be limited to, solid-state memories, optical and magnetic media, and carrier wave signals.

The embodiments disclosed herein may be embodied in hardware and in instructions that are stored in hardware, and may reside, as non-limiting examples, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an Application Specific Integrated Circuit (ASIC). The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art. Those of skill in the art would also understand that information and signals may be represented using any of a variety of different technologies and techniques. As non-limiting examples, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for providing application-to-repository data mapping in a data repository, comprising:
receiving, by a data repository executing on a computing device, a definition of a named data object from an application;
generating a mapping of the named data object to a data element stored in the data repository;
storing the mapping as application metadata in a predefined data structure in the data repository; and
providing, to the application, access to the data element based on the mapping of the named data object to the data element.

2. The method of claim 1, further comprising updating the application metadata to modify the mapping of the named data object to an updated data element.

3. The method of claim 2, wherein updating the application metadata comprises limiting permissions for updating the mapping of the named data object to an owner of the data repository and an owner of the application.

4. The method of claim 1, further comprising updating the application metadata to modify the named data object.

5. The method of claim 4, wherein updating the application metadata to modify the named data object comprises limiting permissions for updating the named data object to an owner of the application.

6. The method of claim 1, wherein the predefined data structure comprises a predefined data structure corresponding to the application.

7. The method of claim 1, further comprising, prior to receiving the definition of the named data object, creating the data element in the data repository.

8. A system for providing application-to-repository data mapping in a data repository, comprising:
at least one communications interface; and
a data repository associated with the at least one communications interface, the data repository comprising a data mapping provider configured to:
receive a definition of a named data object from an application;
generate a mapping of the named data object to a data element stored in the data repository;
store the mapping as application metadata in a predefined data structure in the data repository; and
provide, to the application, access to the data element based on the mapping of the named data object to the data element.

9. The system of claim 8, wherein the data mapping provider is further configured to update the application metadata to modify the mapping of the named data object to an updated data element.

10. The system of claim 9, wherein the data mapping provider is configured to modify the application metadata by limiting permissions for updating the mapping of the named data object to an owner of the data repository and an owner of the application.

11. The system of claim 8, wherein the data mapping provider is further configured to update the application metadata to modify the named data object.

12. The system of claim 11, wherein the data mapping provider is configured to modify the named data object by limiting permissions for updating the named data object to an owner of the application.

13. The system of claim 8, wherein the data mapping provider is configured to store the application metadata in the predefined data structure corresponding to the application.

14. A non-transitory computer-readable medium having stored thereon computer-executable instructions to cause a processor to implement a method, comprising:
receiving a definition of a named data object from an application;
generating a mapping of the named data object to a data element stored in a data repository;
storing the mapping as application metadata in a predefined data structure in the data repository; and
providing, to the application, access to the data element based on the mapping of the named data object to the data element.

15. The non-transitory computer-readable medium of claim 14 having stored thereon the computer-executable instructions to cause the processor to implement the method, further comprising updating the application metadata to modify the mapping of the named data object to an updated data element.

16. The non-transitory computer-readable medium of claim 15 having stored thereon the computer-executable instructions to cause the processor to implement the method, wherein updating the application metadata comprises limiting permissions for updating the mapping of the named data object to an owner of the data repository and an owner of the application.

17. The non-transitory computer-readable medium of claim 14 having stored thereon the computer-executable instructions to cause the processor to implement the method, further comprising updating the application metadata to modify the named data object.

18. The non-transitory computer-readable medium of claim 17 having stored thereon the computer-executable instructions to cause the processor to implement the method, wherein updating the application metadata to modify the named data object comprises limiting permissions for updating the named data object to an owner of the application.

19. The non-transitory computer-readable medium of claim 14 having stored thereon the computer-executable instructions to cause the processor to implement the method, wherein the predefined data structure comprises a predefined data structure corresponding to the application.

20. The non-transitory computer-readable medium of claim 14 having stored thereon the computer-executable instructions to cause the processor to implement the method, further comprising:
prior to receiving the definition of the named data object, creating the data element in the data repository.
